(19) United States
(12) Patent Application Publication
(10) Pub. No.: US 2008/0180353 A1
(43) Pub. Date: Jul. 31, 2008

(54) Composition of digits and method of digit display for digital clock

(75) Inventor: Been-Tzaw Liao, Taichung Hsien (TW)

Correspondence Address: CHARLES E. BAXLEY, ESQ., 90 JOHN STREET, THIRD FLOOR, NEW YORK, NY, 10038, US

(73) Assignee: Guten Electronics Co., Ltd.

(21) Appl. No.: 11/698,590

(22) Filed: Jan. 26, 2007

(51) Int. Cl. G09G 3/04

(52) U.S. Cl. 345/34

(57) ABSTRACT

Composition of digits and method of digit display for digital clocks involve implementing seven main segments, which are ranked as two linked squares sharing a common edge wherein the main segments further enclose two transitional display areas and displaying a plurality of sub-segments in succession fleetingly to constitute a continuous action for connecting a digit with a latter digit until the main segments of the successive digit are completely displayed.

### BACKGROUND OF THE INVENTION

1. Technical Field

The present invention relates to digital clocks and, more particularly, to a transformation method of digits thereof.

2. Description of Related Art

As shown in FIG. 1, a conventional digital clock typically displays time by means of numerical or symbolic characters. For instance, twenty minutes after thirteen o'clock is indicated as 13:20 wherein each of the characters is composed of a plurality of segments. The segments are substantially shaped as bars and every seven segments are grouped as two linked squares sharing a common edge. Thereby, digits of 0 through 9 can be made up by some of the adjacent segments. Further, an integrated circuit (IC) may be implemented for controlling display of the digits.

Said display of the digits is proceeded in order, namely from 1 to 2, from 2 to 3 . . . from 8 to 9 and from 9 to 0. As shown in FIG. 2, transformation of digits is accomplished by turning on some segments while turning off some other segments. By the described means, transformation of characters is displayed jerkily.

### SUMMARY OF THE INVENTION

It is one objective of the present invention to provide an improved a transformation method of digits for digital clocks.

Composition of digits for digital clocks implements seven main segments, which are ranked as two linked squares sharing a common edge wherein the seven main segments further enclose two transitional display areas.

A method of display digits for operating in coordination with the previously discussed composition of digits involves turning on a plurality of sub-segments in succession fleetingly to constitute a continuous action for connecting a digit with a successive digit until the main segments of the successive digit are completely displayed.

It is the main efficacy of the present invention to provide a transformation of digits with a vision effect of gradual and dynamic transforming of digits.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing showing digital time display of a conventional digital clock;

FIG. 2 is an exemplificative transformation of digits of the conventional digital clock;

FIG. 3 is a schematic drawing of the main segments and transitional display are as for composing digits of the disclosed digital clock according to the present invention;

FIG. 4 is a schematic drawing showing a continuous process and phases of transformation from 1 to 2 according to the present invention;

FIG. 5 is a schematic drawing showing a continuous process and phases of transformation from 2 to 3 according to the present invention;

FIG. 6 is a schematic drawing showing a continuous process and phases of transformation from 3 to 4 according to the present invention;

FIG. 7 is a schematic drawing showing a continuous process and phases of transformation from 4 to 5 according to the present invention;

FIG. 8 is a schematic drawing showing a continuous process and phases of transformation from 5 to 6 according to the present invention;

FIG. 9 is a schematic drawing showing a continuous process and phases of transformation from 6 to 7 according to the present invention;

FIG. 10 is a schematic drawing showing a continuous process and phases of transformation from 7 to 8 according to the present invention;

FIG. 11 is a schematic drawing showing a continuous process and phases of transform at ion from 8 to 9 according to the present invention; and

FIG. 12 is a schematic drawing showing a continuous process and phases of transformation from 9 to 0 according to the present invention.

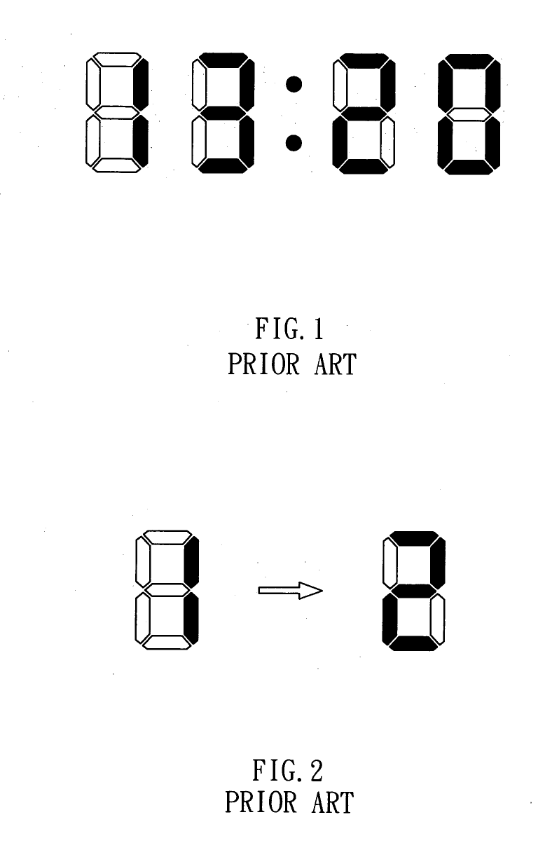

### DETAILED DESCRIPTION OF THE PREFERRED EMBODIMENT

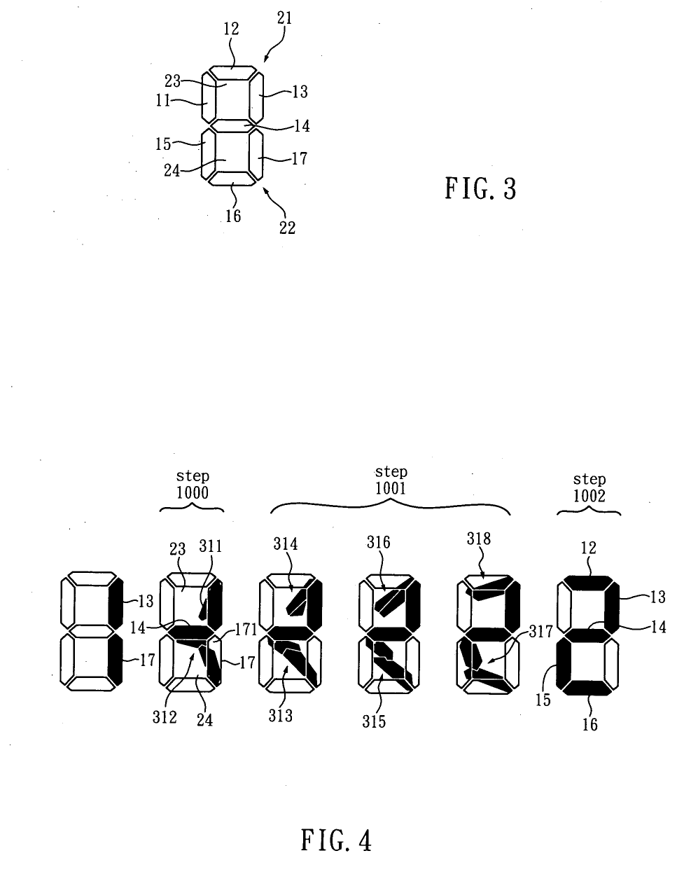

In FIG. 3, the above-discussed seven bar-shaped main segments 11, 12, 13, 14, 15, 16, 17 can be seen ranked as two linked squares 21, 22 sharing a common edge wherein the seven main segments further enclose two transitional display areas 23, 24.

Transformation of digits means transforming a digit, e.g. 1, into a successive digit, e.g. 2. The disclosed transformation method involves displaying a plurality of sub-segments (will be illustrated through following embodiments) in succession fleetingly in the transitional display areas 23, 24 to constitute a continuous action until the main segments of the successive digit are completely displayed. During the session of displaying the sub-segments, display of some main segments of the digit may be turned off if necessary (will be illustrated through following embodiments). Also, during the session of displaying the sub-segments, display of some segmental areas of the successive digit may be turned off if necessary (will be illustrated through following embodiments). The plural sub-segments are also shaped as bars, and can even be shaped in the identical shape as the main segments. Further, said display and transformation of the digits may be under the control of an integrated circuit (IC).

For illustrating the present invention in detail, said main segments are respectively defined as a first, a second, a third, a fourth, a fifth, a sixth and a seven segments. FIG. 4 through FIG. 12 are provided for describing the exemplificative modes of transformation of digits from 1 to 0. These modes are fundamental for displaying time and cannot be parted or divided.

As shown in FIG. 4, a mode of transforming digit 1 into digit 2 is illustrated, wherein digit 1 is composed of the third main segment 13 and the seventh main segment 17 while digit 2 is composed of the second, third, fourth, fifth and sixth main segments 12, 13, 14, 15, 16 and includes following steps.

Step 1000, turning off a segmental area 171 of the seventh main segment 17, turning on the fourth main segment 14 and fleetingly turning on two sub-segments 311, 312 in said two transitional display areas 23, 24;

Step 1001, turning on a plurality of sub-segments 313, 314, 315, 316, 317, 318 in succession fleetingly in the two transitional display areas 23, 24 to constitute a continuous action that forwards toward the second main segment 12 and the fifth as well as the sixth main segments 15, 16; and

Step 1002, completely turning off the seventh main segment 17 and turning on the second, fifth and sixth main segments 12, 15, 16.

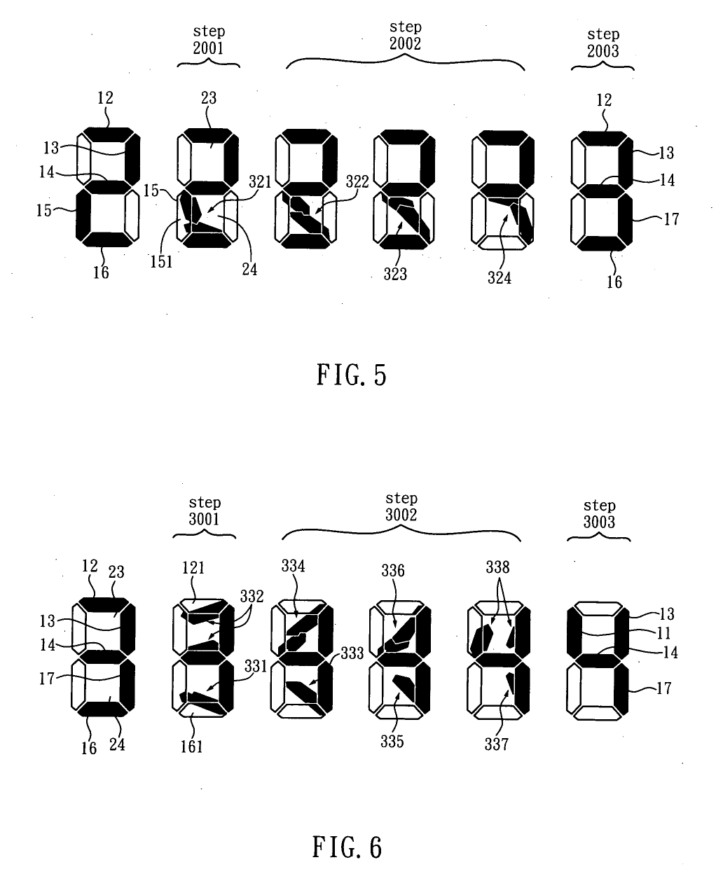

As shown in FIG. 5, a mode of transforming digit 2 into digit 3 is illustrated, wherein while digit 2 is composed as previously discussed, digit 3 is composed of the second, third, fourth, sixth and seventh main segments 12, 13, 14, 16, 17 and includes following steps:

Step 2001, turning off a segmental area 151 of the fifth main segment 15, and fleetingly turning on a sub-segment 321 in the lower transitional display area 24;

Step 2002, displaying a plurality of sub-segments 322, 323, 324 in succession fleetingly in the lower transitional display area 24 to constitute a continuous action that forwards toward the seventh main segment 17; and

Step 2003, completely turning off the fifth main segment 15 and turning on the seventh main segment 17.

As shown in FIG. 6, a mode of transforming digit 3 into digit 4 is illustrated, wherein while digit 3 is composed as previously discussed, digit 4 is composed of the first, third, fourth, and seventh main segments 11, 13, 14, 17 and includes following steps:

Step 3001, turning off two segmental area 121, 161 of the second and sixth main segments 12, 16 and fleetingly turning on two sub-segments 331, 332 in the transitional display areas 23, 24;

Step 3002, displaying a plurality of sub-segments 333, 334, 335, 336, 337, 338 in succession fleetingly in the transitional display areas 23, 24 to constitute a continuous action that forwards toward the first, third and seventh main segments 11, 13, 17; and

Step 3003, completely turning off the second and sixth main segments 12, 16 and turning on the first main segment 11.

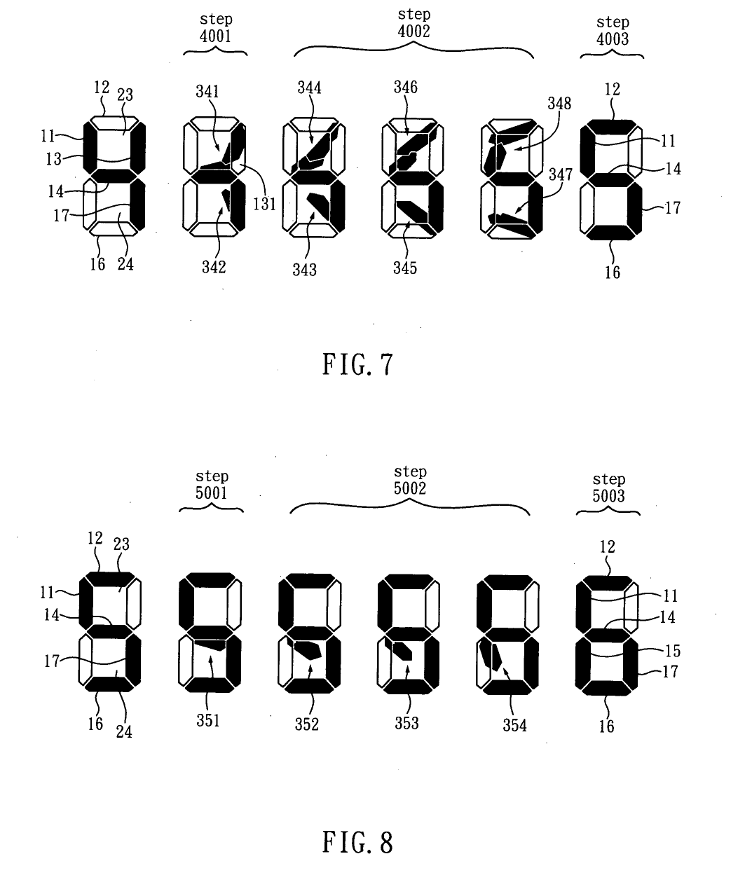

As shown in FIG. 7, a mode of transforming digit 4 into digit 5 is illustrated, wherein while digit 4 is composed as previously discussed, digit 5 is composed of the first, second, fourth, sixth and seventh main segments 11, 12, 14, 16, 17 and includes following steps:

Step 4001, turning off the first main segment 11 and a segmental area 131 of the third main segment 13, and fleetingly turning on two sub-segments 341, 342 in the transitional display areas 23, 24;

Step 4002, displaying a plurality of sub-segments 343, 344, 345, 346, 347, 348 in succession fleetingly in the transitional display areas 23, 24 to constitute a continuous action that forwards toward the first, second and sixth main segments 11, 12, 16; and

Step 4003, completely turning off the third main segment 13 and turning on the second and sixth main segments 12, 16.

As shown in FIG. 8, a mode of transforming digit 5 into digit 6 is illustrated, wherein while digit 5 is composed as previously discussed, digit 6 is composed of the first, second, fourth, fifth, sixth and seventh main segments 11, 12, 14, 16, 17 and includes following steps:

Step 5001, fleetingly turning on a sub-segment 351 in the lower transitional display area 24;

Step 5002, displaying a plurality of sub-segments 352, 353, 354 in succession fleetingly in the lower transitional display area 24 to constitute a continuous action that forwards toward the fifth main segment 15; and

Step 5003, turning on the fifth main segment 15.

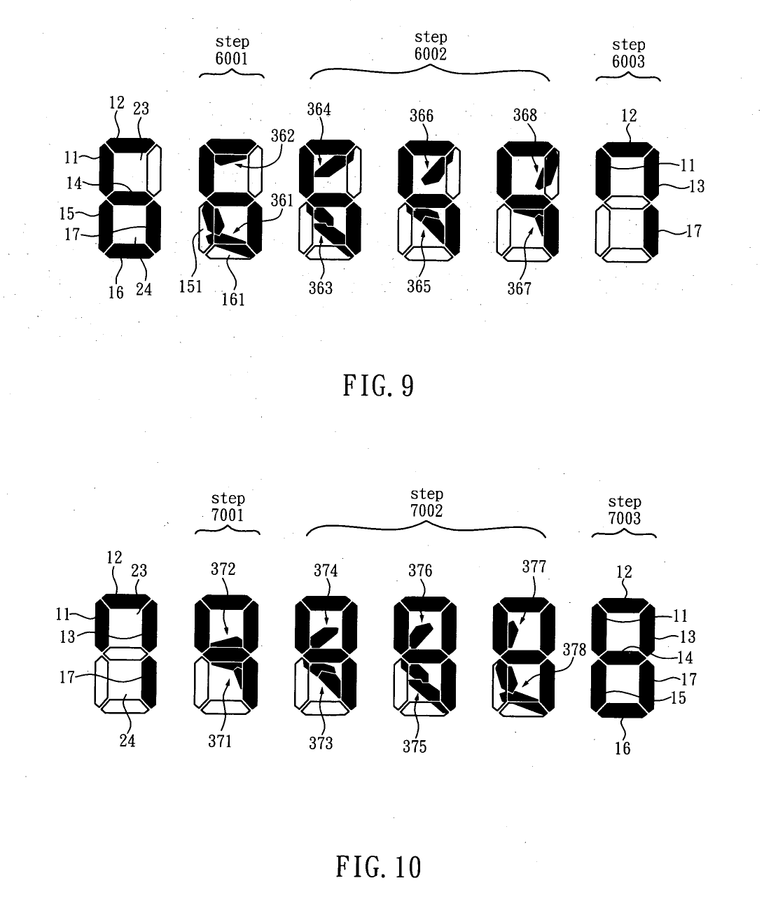

As shown in FIG. 9, a mode of transforming digit 6 into digit 7 is illustrated, wherein while digit 6 is composed as previously discussed, digit 7 is composed of the first, second, third and seventh main segments 11, 12, 13, 17 and includes following steps:

Step 6001, turning off the segmental areas 151, 161 of the fifth and sixth main segments 15, 16 and fleetingly turning on two sub-segments 361, 362 in the transitional display areas 23, 24;

Step 6002, displaying some of the sub-segments 363, 364, 365, 366, 367, 368 in succession fleetingly in the transitional display areas 23, 24 to constitute a continuous action that forwards toward the third, fourth and seventh main segments 13, 14, 17; and

Step 6003, turning off the fourth main segment 14 and turning on the third main segment 13.

As shown in FIG. 10, a mode of transforming digit 7 into digit 8 is illustrated, wherein while digit 7 is composed as previously discussed, digit 8 is composed of the first, second, third, fourth, fifth, sixth and seventh main segments 11, 12, 13, 14, 15, 16, 17 and includes following steps:

Step 7001, turning on the fourth main segment 14 and fleetingly turning on two sub-segments 371, 372 in the transitional display areas 23, 24;

Step 7002, displaying some of the sub-segments 373, 374, 375, 376, 377, 378 in succession fleetingly in the transitional display areas 23, 24 to constitute a continuous action that forwards toward the first, fifth and sixth main segments 11, 15, 16; and

Step 7003, turning on the fifth and sixth main segments 15, 16.

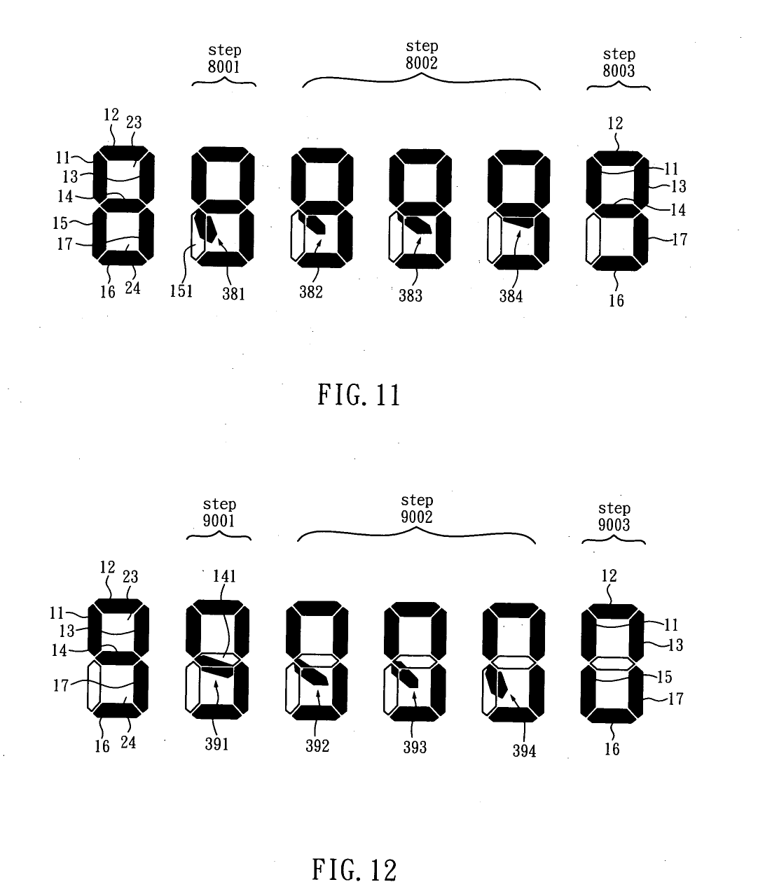

As shown in FIG. 11, a mode of transforming digit 8 into digit 9 is illustrated, wherein while digit 8 is composed as previously discussed, digit 9 is composed of the first, second, third, fourth, sixth and seventh main segments 11, 12, 13, 14, 16, 17 and includes following steps:

Step 8001, turning off the segmental area 151 of the fifth main segment 15, and fleetingly turning on a sub-segment 381 in the lower transitional display area 24;

Step 8002, displaying some of the sub-segments 382, 383, 384 in succession fleetingly in the lower transitional display area 24 to constitute a continuous action that forwards toward the fourth main segment 14; and

Step 8003, completely turning off the fifth main segment 15.

As shown in FIG. 12, a mode of transforming digit 9 into digit 0 is illustrated, wherein while digit 9 is composed as previously discussed, digit 0 is composed of the first, second, third, fifth, sixth and seventh main segments 11, 12, 13, 15, 16, 17 and includes following steps:

Step 9001, turning off a segmental area 141 of the fourth main segment 14, and fleetingly turning on a sub-segment 391 in the lower transitional display area 24;

Step 9002, displaying a plurality of sub-segments 392, 393, 394 in succession fleetingly in the lower transitional display area 24 to constitute a continuous action that forwards toward the fifth main segment 15; and

Step 9003, completely turning off the fourth main segment 14 and turning on the fifth main segment 15.

The present invention distinctively implements foregoing transformation modes to perform a vision effect of gradual transforming of digits. The disclosed transformation method is applicable to liquid crystal display watches, liquid crystal display wall clocks, liquid crystal display table clocks, radio controlled clocks, time display on mobile phones and time display of other electronic products.

Although some particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. Composition of digits for digital clocks, which comprises:
seven main segments, which are ranked as two linked squares sharing a common edge; and
two transitional display areas enclosed by the main segments.

2. A method of digit display for operating in coordination with the composition of claim 1, which is to transform a digit into a successive digit and comprises:
displaying a plurality of sub-segments in succession fleetingly to constitute a continuous action until the essential main segments of the successive digit are completely displayed.

3. The method of claim 2, wherein during the session of displaying the sub-segments, some main segments of the digit are turned off.

4. The method of claim 2, wherein during the session of displaying the sub-segments, some segmental areas of the digit are turned off.

5. The method of claim 2, wherein the sub-segments are shaped identically as the main segments.
